(19) United States
(12) Patent Application Publication
(10) Pub. No.: US 2005/0102514 A1
(43) Pub. Date: May 12, 2005

(54) Method, apparatus and system for pre-establishing secure communication channels

(75) Inventors: Thomas Bergenwall, Espoo (FI); Tapio Vuorinen, Espoo (FI); Tommi Linnakangas, Espoo (FI)

Correspondence Address: Ericsson, Inc.;M/S EVW 2-C-2, 6300 Legacy Drive, Plano, TX, 75024, US

(73) Assignee: Telefonaktiebolaget LM Ericsson (Publ), Stockholm (SE)

(21) Appl. No.: 10/705,079

(22) Filed: Nov. 10, 2003

(51) Int. Cl. H04L 9/00

(52) U.S. Cl. 713/168

(57) ABSTRACT

The present invention provides a method, apparatus and system for pre-establishing a secure communication channel by detecting one or more trigger events (302), determining whether the secure communication channel will be needed in the future (304) and establishing the secure communication channel before the secure communication channel is needed (308-316). The secure communication channel is established by sending a SA Query (308) and determining whether the SA Query matches one or more security policies (310). If the SA Query matches the one or more security policies, the present invention determines whether the SA Query matches a SA (314). If the SA Query does not match the SA, a SA is negotiated (318) and a SA Query successful message is returned (316). This method can be implemented as a computer program embodied on a computer readable medium wherein each step is executed by one or more code segments.

### FIELD OF THE INVENTION

The present invention relates generally to the field of communications and, more particularly, to a method, apparatus and system for pre-establishing secure communication channels.

### BACKGROUND OF THE INVENTION

Internet Protocol Security (“IPsec”) is a security architecture standard for the Internet Protocol (“IP”) described by the Internet Engineering Taskforce (“IETF”) in RFC 2401. The security is mainly provided through the use of different hash algorithms and symmetric ciphers, which require pre-shared keys. The actual packet transformations are described in the security protocols Authentication Header (“AH”) [RFC 1826] and Encapsulating Security Payload (“ESP”) [RFC 1827]. The keys are stored in Security Associations (“SAs”), which contain all security parameters related to certain traffic flows. These SAs can be configured manually, but for scalability reasons dynamic SA generation is preferable. Instead of configuring manual SAs, Security Policies (“SPs”) are configured and a Key Management Daemon is assigned the responsibility for negotiating SAs according to the existing SPs. SA negotiations are only started by outgoing packets matching SPs, if they don't belong to the traffic flow of any existing SAs. Currently, the only widely used Key Management Daemon in the IPsec context is Internet Key Exchange (“IKE”) [RFC 2409].

Currently the only ways to establish a secure IPsec connection is either to use manual SAs or to use SPs and let a Key Management Daemon negotiate the SAs when needed. In large systems, the use of manual SAs would cause huge configuration efforts, which in practice rules out the option. Dynamic SA negotiation is thus the only realistic alternative. One problem with this option is that the SA negotiation procedure is time consuming. Using IKE as the Key Management Daemon, the SA negotiation procedure takes roughly 10 to 1000 times longer than the actual IPsec processing. Another problem is that IPsec implementations, in order to be resistant against Denial of Service Attacks, might be forced to drop packets belonging to the traffic flow during the SA negotiation. It is often important that IP packets in data flows are protected. IPsec provides the necessary protection, but introduces some overhead while security (i.e. SAs) is established. This is especially problematic for real-time traffic where these delays can cause unacceptable damage. Both these problems are especially problematic for real-time traffic where these delays can cause unacceptable damage. There is, therefore, a need for a method, apparatus and system that overcomes these problems.

### SUMMARY OF THE INVENTION

The present invention provides a method, apparatus and system for pre-establishing secure communication channels. Although the present invention is adaptable to any packet-based communication system, it is highly suited to improve connection times in networks using IP packets, such as the Internet and Voice over IP (“VoIP”) systems. Moreover, the problems solved by the present invention are not network or vendor specific, and are prominent for any entity providing a secure mobile IP access. The present invention solves the previously described problems by negotiating security associations (“SAs”) for all traffic sensitive to delays in advance. When the needed secure connections are established, they normally don't expire. This is enabled through a dynamic re-keying scheme in IP packet security protocol (“IPsec”). When IPsec detects that a SA is about to expire, it acquires for a new SA before killing the old one. It is, however, far from trivial to be able to negotiate all needed SAs in advance in a scalable and controlled way. If the IPsec system is used as a gateway it might be close to impossible for the management to generate the traffic needed to start the negotiation of all SAs needed to protect the sensitive traffic.

The present invention provides several benefits in large networks. First, the system can establish all necessary SAs for all needed traffic in a controlled manner before the real traffic starts, thus reducing the connection time observed by the user. Furthermore, after a user is attached to the network, he or she can be sure that a communication will not fail due to the fact that a set up of a secure communication channel fails. Second, the security association query (“SA Query”) of the present invention can be incorporated in the user interface. As a result, a network operator can verify the configuration of a secured connection in the case where the operator has no possibility to generate IP traffic based on the selectors of the configured security policy (“SP”). Third, since the SAs are created before the real data flow starts, all of the packets in the data flow are protected and no packets are lost. Finally, the present invention allows an operator to charge the user for the secure communication channel that is set up and available for the user, or include it as part of a higher priced Quality of Service (“QoS”) package.

More specifically, the present invention provides a method for pre-establishing a secure communication channel by detecting one or more trigger events, determining whether the secure communication channel will be needed in the future and establishing the secure communication channel before the secure communication channel is needed. The one or more trigger events may include a registration request, an attachment of a client or an expected attachment of a client. Moreover, the determination of whether the secure communication channel will be needed in the future can be based on a user profile or historical data. Typically, a secure communication channel is needed whenever a control packet or payload packet is received that relates to the one or more trigger events and matches one or more security policies (“SPs”). This method can be implemented as a computer program embodied on a computer readable medium wherein each step is executed by one or more code segments.

In addition, the present invention provides a method for pre-establishing a secure communication channel by receiving a security association query (“SA Query”) from a privileged application and determining whether the SA Query matches one or more security policies. A privileged application is an application that is allowed to send the SA Query message via an interface towards the packet security protocol. The SA Query is a message indicating that a security association is needed. If the SA Query matches the one or more security policies, the present invention determines whether the SA Query matches a security association (“SA”). If the SA Query matches the SA, the present invention sends a SA Negotiation Request to a key management exchange. The present invention sends a SA Query successful message to the privileged application indicating that the secure communication channel has been pre-established whenever the SA Query matches the security association or a negotiated SA pair is received from the key management exchange. The present invention sends a SA Query failure message to the privileged application whenever the SA Query does not match the one or more security policies or a negotiation failure message is received from the key management exchange. This method can be implemented as a computer program embodied on a computer readable medium wherein each step is executed by one or more code segments.

The present invention also provides an apparatus that includes a packet processor, a packet security protocol instance operating within the packet processor, and a privileged application operating within the packet processor. The privileged application detects one or more trigger events, determines whether a secure communication channel will be needed in the future and sends a message to the packet security protocol instance to establish the secure communication channel before the secure communication channel is needed. The one or more trigger events may include a registration request, an attachment of a client or an expected attachment of a client. Moreover, the determination of whether the secure communication channel will be needed in the future can be based on a user profile or historical data. Typically, a secure communication channel is needed whenever a control packet or payload packet is received that relates to the one or more trigger events and matches one or more SPs.

The apparatus may also include a security policies database communicably coupled to the packet security protocol, a security association database communicably coupled to the packet security protocol, and a key management daemon communicably coupled to the packet security protocol. The packet security protocol, which can be an IPsec instance, receives a SA Query from the privileged application, determines whether the SA Query matches one or more SPs stored in the securities policies database. The packet security protocol also determines whether the SA Query matches a SA stored in the security association database (“SAD”) whenever the SA Query matches the one or more SPs. The packet security protocol sends a SA Negotiation Request to the key management daemon whenever the SA Query does not match the SA. The packet security protocol also sends a SA Query successful message to the privileged application indicating that the secure communication channel has been pre-established whenever the SA Query matches the SA or a negotiated SA pair is received from the key management exchange. In addition, the packet security protocol sends a SA Query failure message to the privileged application whenever the SA Query does not match the one or more SPs or a negotiation failure message is received from the key management exchange.

In addition, the present invention provides a system that includes a first network, a second network and a packet communications device communicably coupled to the first network and the second network. The packet communications device includes a packet processor, a packet security protocol instance operating within the packet processor, and a privileged application operating within the packet processor that detects one or more trigger events, determines whether a secure communication channel will be needed in the future and sends a message to the packet security protocol instance to establish the secure communication channel before the secure communication channel is needed. The first and second networks can be the Internet, a wide area network (“WAN”), a local area network (“LAN”), an access network or any other packet-based network. One or more computers, IP phones, personal data assistants (“PDAs”), mobile stations or other packet-based communication devices can be communicably coupled to the first or second network.

### BRIEF DESCRIPTION OF THE DRAWINGS

The above and further advantages of the invention may be better understood by referring to the following description in conjunction with the accompanying drawings, in which:

FIG. 1 is a block diagram of a system in accordance with one embodiment of the present invention;

FIG. 2 is a flow chart illustrating IPsec packet processing in accordance with the prior art;

FIG. 3 is a flow chart illustrating the method for pre-establishing secure communication channels in accordance with one embodiment of the present invention;

FIG. 4 is a flow chart illustrating IPsec packet processing in accordance with one embodiment of the present invention;

FIG. 5 is a signaling diagram for a Security Association Query resulting in a successful Security Association negotiation in accordance with one embodiment of the present invention;

FIG. 6 is a signaling diagram for a Security Association Query when a matching Security Association exists in accordance with one embodiment of the present invention;

FIG. 7 is a signaling diagram for a Security Association Query resulting in a failed Security Association negotiation in accordance with one embodiment of the present invention;

FIG. 8 is a signaling diagram for a Security Association Query when no matching Security Policy exists in accordance with one embodiment of the present invention;

FIG. 9 is a signaling diagram for a Packet Data Serving Node in accordance with another embodiment of the present invention;

FIG. 10 is a signaling diagram for a Packet Data Serving Node providing security level one (control only) in accordance with another embodiment of the present invention;

FIG. 11 is a signaling diagram for a Packet Data Serving Node providing security level two (payload only) in accordance with another embodiment of the present invention;

FIG. 12 is a signaling diagram for a Packet Data Serving Node providing security level three (control and payload) in accordance with another embodiment of the present invention; and

FIG. 13 is a signaling diagram for a Packet Data Serving Node providing security level four (no security) in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates to packet-based communication systems, and more particularly, to Internet Protocol (“IP”) communication systems. It will be understood that, although the description herein refers to an IP-based communication environment, the concepts of the present invention are applicable to any packet-based environment.

More specifically, the present invention provides a method, apparatus and system for pre-establishing secure communication channels. Although the present invention is adaptable to any packet-based communication system, it is highly suited to improve connection times in networks using IP packets, such as the Internet and Voice over IP (“VoIP”) systems. Moreover, the problems solved by the present invention are not network or vendor specific, and are prominent for any entity providing a secure mobile IP access. The present invention solves the previously described problems by negotiating security associations (“SAs”) for all traffic sensitive to delays in advance. When the needed secure connections are established, they normally don't expire. This is enabled through a dynamic re-keying scheme in IP packet security protocol (“IPsec”). When IPsec detects that a SA is about to expire, it acquires for a new SA before killing the old one. It is, however, far from trivial to be able to negotiate all needed SAs in advance in a scalable and controlled way. If the IPsec system is used as a gateway it might be close to impossible for the management to generate the traffic needed to start the negotiation of all SAs needed to protect the sensitive traffic.

The present invention provides several benefits in large networks. First, the system can establish all necessary SAs for all needed traffic in a controlled manner before the real traffic starts, thus reducing the connection time observed by the user. Furthermore, after a user is attached to the network, he or she can be sure that a communication will not fail due to the fact that a set up of a secure communication channel fails. Second, the security association query (“SA Query”) of the present invention can be incorporated in the user interface. As a result, a network operator can verify the configuration of a secured connection in the case where the operator has no possibility to generate IP traffic based on the selectors of the configured security policy (“SP”). Third, since the SAs are created before the real data flow starts, all of the packets in the data flow are protected and no packets are lost. Finally, the present invention allows an operator to charge the user for the secure communication channel that is set up and available for the user, or include it as part of a higher priced Quality of Service (“QoS”) package.

The present invention defines a new signaling interface to IPsec, which can be used by the management or any other privileged application for sending SA Queries to IPsec. A privileged application is an application that is allowed to send the SA Query message via the interface towards the packet security protocol IPsec. These queries result in negotiation of the queried SAs and the privileged application is informed about the negotiation results. When receiving a SA Query, IPsec treats it like an outgoing IP packet. The queried selectors contained in the SA Query are matched against the selectors in existing SPs. If no SP matches the query, the privileged application is informed about the failure. If a matching SP is found, the selectors in the query are matched against the selectors in possible existing SAs. If a matching SA is found, the privileged application is informed about the success. If no matching SA is found, a SA negotiation is started. When the negotiation is finished the privileged application is informed about the result. In this context, IPsec is the server and the privileged application the client. The present invention is protected from non-privileged applications in a very similar manner as the management interface is protected. The new interface is protected against policy violations, since no actions are taken unless the selectors in the query form a subset of the selectors in some existing SP. Assuming that the interface only is available for trusted privileged applications it does not create any new Denial of Service threats.

As a result, the present invention allows privileged applications to start SA negotiations, passing a complete set of packet selectors through a signaling interface in IPsec. The passed selectors are ensured to be according to some existing SP before the actual SA negotiation is started. When a packet is passed from the application protocol instance to the to the IPsec protocol instance, the IPsec protocol instance performs a check whether a secure communication channel is established for the application program. If the secure communication channel is established, the packet is transmitted via the pre-established channel. In addition, a number of SAs can be used by one application protocol instance to schedule the establishment of the different secure communication channels.

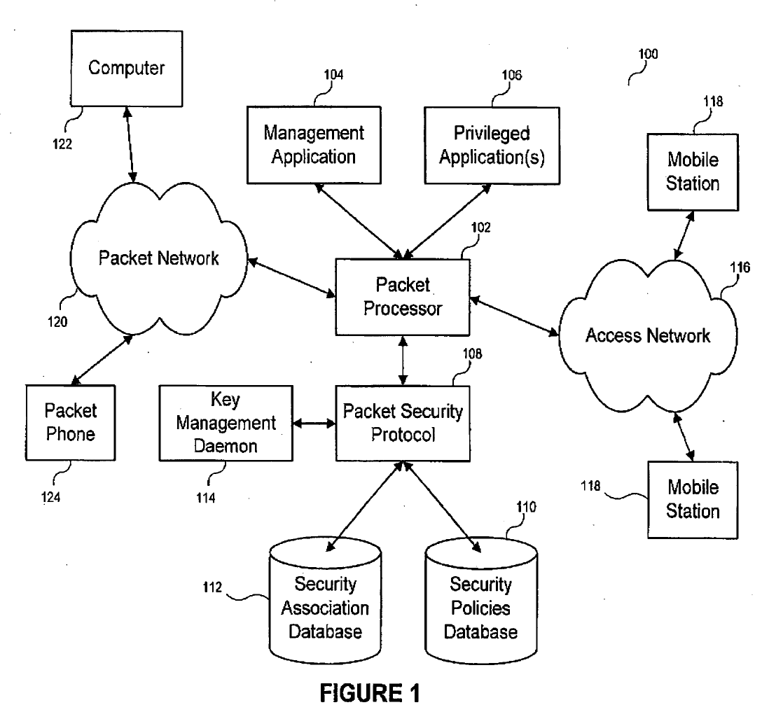

Referring now to FIG. 1, a block diagram of a system 100 in accordance with one embodiment of the present invention is shown. The system 100 includes a first network 116 (e.g., an access network), a second network 120 (e.g., a packet-based network) and a packet communications device (collectively 102, 104, 106, 108, 110, 112 and 114) communicably coupled to the first network 116 and the second network 120. The first and second networks 166, 120 can be the Internet, a wide area network (“WAN”), a local area network (“LAN”), an access network or any other packet-based network. One or more computers 122, IP phones 124, personal data assistants (“PDAs”), mobile stations 118 or other packet-based communication devices can be communicably coupled (landline, wireless, satellite, hardwired, etc.) to the first network 116 or second network 120.

The packet communications device (collectively 102, 104, 106, 108, 110, 112 and 114) can be gateway, router, firewall, server, communications node, switch, etc. The packet communication device (collectively 102, 104, 106, 108, 110, 112 and 114) may include a packet processor 102, a packet security protocol 108 instance operating within the packet processor 102, and a privileged application (management application 104 or other privileged application 106, such as a packet data serving node (“PDSN”)) operating within the packet processor 104. The privileged application 104 or 106 detects one or more trigger events, determines whether a secure communication channel will be needed in the future and sends a message to the packet security protocol 108 instance to establish the secure communication channel before the secure communication channel is needed. The one or more trigger events may include a registration request, an attachment of a client, an expected attachment of a client or any other identifiable event or series of events where it is desirable to establish the secure communication channel before it is actually needed. In other words, the secure communication channel is pre-established. The privileged application (104 or 106) determines whether the secure communication channel will be needed in the future based on various parameters, such as an indication (e.g., a security level) in a user's profile that a secure communication channel is needed, historical data regarding the use of secure communication channels by the user (e.g., a log file containing historical day times and attachment procedures for a client), a QoS profile, a user determined setting transmitted by the device, etc. Typically, the secure communication channel is needed whenever a control packet or payload packet is received that relates to the one or more trigger events and matches one or more SPs.

The privileged application (104 or 106) may store an indication that the secure communication channel has been established. Thereafter when the privileged application (104 or 106) receives a control or payload packet, it determines whether the received packet is associated with the pre-established secure communication channel, and sends the received packet using the pre-established secure communication channel whenever the received packet is associated with the pre-established secure communication channel. The privileged application (104 or 106) establishes the secure communication channel by sending a SA Query to the packet security protocol 108 instance (e.g., an IPsec protocol instance). The SA Query is a message indicating that a security association is needed. The secure communication channel can be used for control packets only, payload packets only, or both control and payload packets.

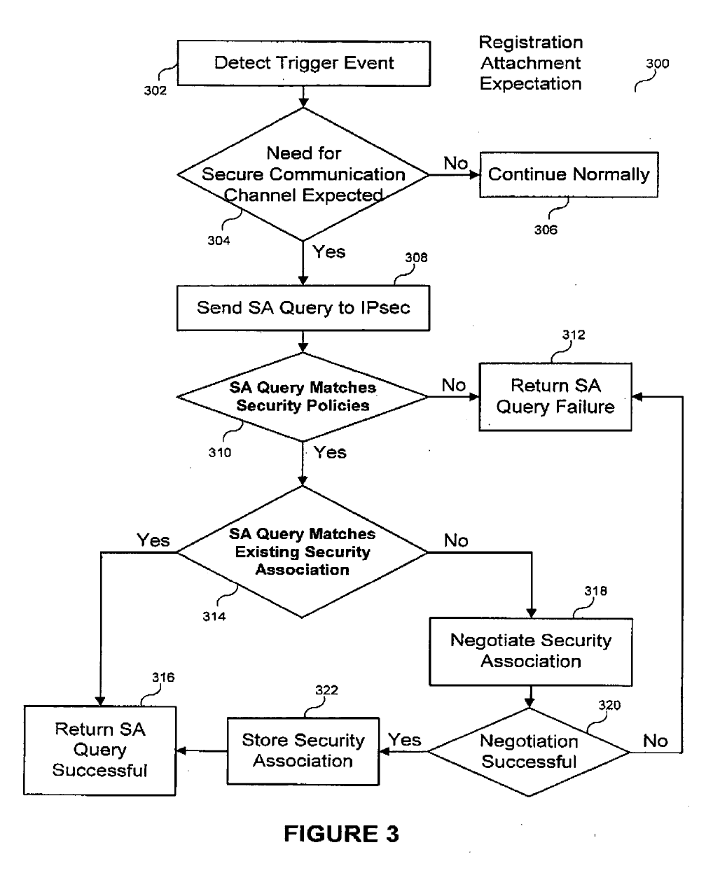

A security policies database (“SPD”) 110, security association database (“SAD”) 112, and key management daemon 114 (e.g., an Internet key exchange (“IKE”)) are communicably coupled to the packet security protocol 108. The SPD 110 contains the SPs established by the owner or operator of the packet security protocol 108 to control the implementation and use of the packet security protocol 108. For example, the owner or operator may specify end-points, such as user terminals, to which packets may be sent, or from which they may be received, the particular security levels to be used for encrypting packets, etc. Typically, the SPD 110 is distributed among several entities of the packet security protocol node. The SAD 112 contains details of the existing SAs and the respective security parameter index (“SPI”). The key management daemon 114 is responsible for negotiating SAs with peer key management daemons. The operation of the packet security protocol 108 instance will be described below in reference to FIG. 3-8.

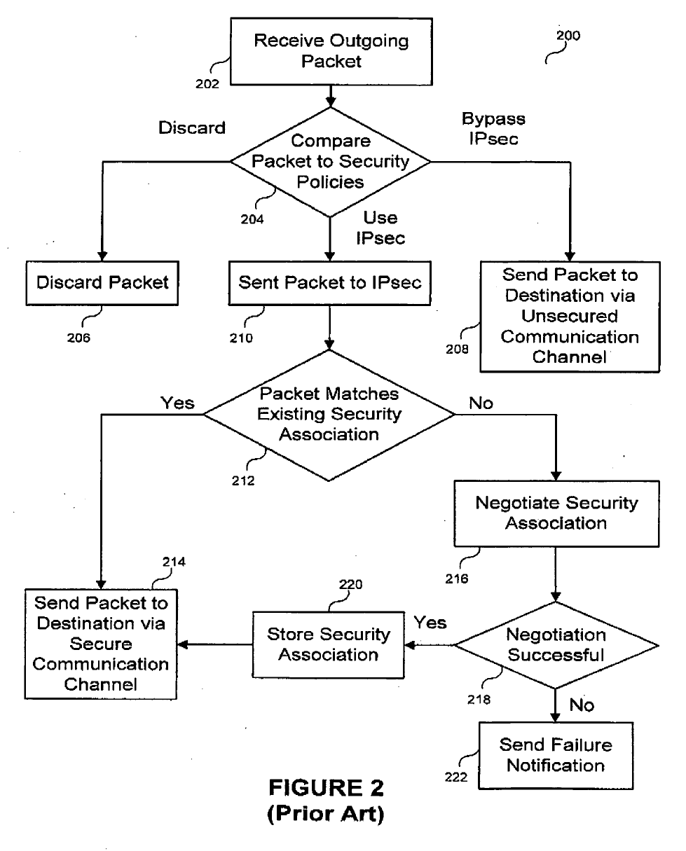

The operation of the IPsec packet processing 200 in accordance with the prior art will now be briefly discussed in reference to FIG. 2. The establishment of a secure connection is initiated when a first packet is sent from an application protocol instance to an IPsec protocol instance. This process requires the setting up of a secure channel, a mutual authentication of the peer IPsec protocol instances and the negotiation of algorithms and keys (collectively referred to as an SA) used in the secure communication. This procedure takes some seconds for an application that is started for the first time. More specifically, the IPsec receives an outgoing packet (control or payload) in block 202 and compares the packet to SPs stored in the SPD in decision block 204. This comparison results in three possible outcomes: discard the packet, use IPsec to process the packet, or bypass IPsec. Obviously, if the comparison indicates that the packet should be discarded, as determined in decision block 204, the packet is discarded in block 206. Likewise, if the comparison indicates that IPsec should be bypassed, as determined in decision block 204, the packet is sent to its destination via an unsecured communication channel in block 208. If, however, the packet should be processed with IPsec, as determined in decision block 204, the packet is sent to IPsec in block 210.

IPsec processes the packet by comparing it to existing SAs stored in the SAD in decision block 212. If the packet matches an existing SA, as determined in decision block 212, the packet is sent to the destination via a secure communication channel in block 214. An SA matching the packet indicates that a secure communication channel has already been established for the packet. If, however, the packet does not match an existing SA, as determined in decision block 212, the SA is negotiated in block 216 by sending a SA Negotiation Request to the key management daemon or exchange. If the SA negotiation was successful (a negotiated SA pair is received from the key management daemon or exchange), as determined in decision block 218, the resulting SA is stored in the SAD in block 220 and the packet is sent to the destination via the secure communication channel in block 214. If, however, the SA negotiation failed (a negotiation failure message is received from the key management daemon or exchange), as determined in decision block 218, a failure notification is sent to the responsible application in block 222 and the packet will likely be lost.

Now referring back to the present invention, FIG. 3 is a flow chart illustrating a method 300 for pre-establishing secure communication channels in accordance with one embodiment of the present invention. The secure communication channel pre-establishing process 300 begins by the detection of one or more trigger events in block 302. The one or more trigger events may include a registration request, an attachment of a client, an expected attachment of a client or any other identifiable event or series of events where it is desirable to establish the secure communication channel before it is actually needed. In other words, the secure communication channel is pre-established. If a secure communication channel is not expected to be needed in the future, as determined in decision block 304, normal processing continues in block 306. If, however, a secure communication channel is expected to be needed in the future, as determined in decision block 304, the secure communication channel is established before the secure communication channel is needed in blocks 308-316. The determination of whether the secure communication channel will be needed in the future is based on various parameters, such as an indication (e.g., a security level) in a user's profile that a secure communication channel is needed, historical data regarding the use of secure communication channels by the user (e.g., a log file containing historical day times and attachment procedures for a client), a QoS profile, a user determined setting transmitted by the device, etc. Typically, the secure communication channel is needed whenever a control packet or payload packet is received that relates to the one or more trigger events and matches one or more SPs. The process may store an indication that the secure communication channel has been established. Thereafter, when a control or payload packet is received, the process can determine whether the received packet is associated with the pre-established secure communication channel and send the received packet using the pre-established secure communication channel whenever the received packet is associated with the pre-established secure communication channel.

The pre-establishment of a secure communication channel is initiated by sending a SA Query to the IPsec (a packet security protocol instance) in block 308. The SA Query is a message indicating that a security association is needed and includes a set of packet selectors, such as a source address, a destination address, a protocol, a source port and a destination port. The process determines whether the SA Query matches one or more SPs stored in the SPD in decision block 310. If the SA Query does not match any SP, a SA Query failure message is returned in block 312. If, however, the SA Query does match one or more SPs, as determined in decision block 310, the process determines whether the SA Query matches an existing SA stored in the SAD in decision block 314. If the SA Query does match an existing SA, a SA Query successful message is returned in block 316. If, however, the SA Query does not match an existing SA, as determined in decision block 314, a SA is negotiated in block 318 by sending a SA Negotiation Request to the key management daemon or exchange. If the SA negotiation was not successful (a negotiation failure message is received from the key management daemon or exchange), as determined in decision block 320, a SA Query failure message is returned in block 312. If, however, the SA negotiation was successful (a negotiated SA pair is received from the key management daemon or exchange), as determined in block 320, the negotiated SA is stored in the SAD in block 322 and a SA Query successful message is returned in block 316. The resulting secure communication channel can be used for control packets only, payload packets only, or both control and payload packets.

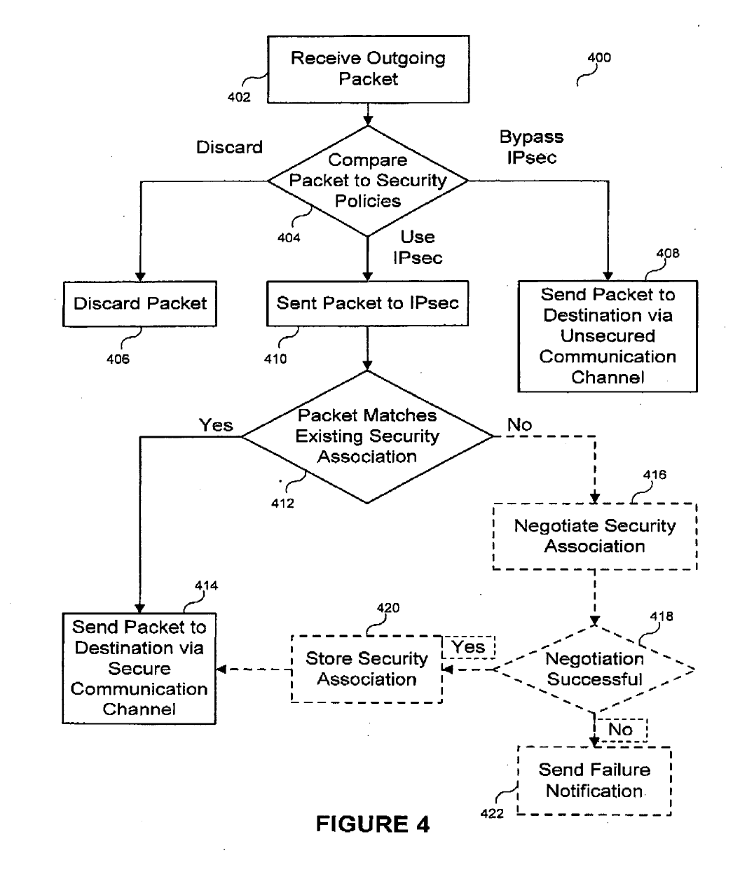

Referring now to FIG. 4, a flow chart illustrating IPsec packet processing 400 in accordance with one embodiment of the present invention is shown. The IPsec receives an outgoing packet (control or payload) in block 402 and compares the packet to SPs stored in the SPD in decision block 404. This comparison results in three possible outcomes: discard the packet, use IPsec to process the packet, or bypass IPsec. Obviously, if the comparison indicates that the packet should be discarded, as determined in decision block 404, the packet is discarded in block 406. Likewise, if the comparison indicates that IPsec should be bypassed, as determined in decision block 404, the packet is sent to its destination via an unsecured communication channel in block 408. If, however, the packet should be processed with IPsec, as determined in decision block 404, the packet is sent to IPsec in block 410.

IPsec processes the packet by comparing it to existing SAs stored in the SAD in decision block 412. If the packet matches an existing SA, as determined in decision block 412, the packet is sent to the destination via a secure communication channel in block 414. An SA matching the packet indicates that a secure communication channel has already been established for the packet. Notably, process 400 in accordance with the present invention differs from the prior art process 200 (FIG. 2) in that the packet will almost always match an existing SA, as determined in decision block 412, because the SA Query process 300 (FIG. 3) will have pre-established the secure communication channel. As a result, blocks 416, 418, 420 and 422 will rarely be used as indicated by the dashed lines. Blocks 416, 418, 420 and 422 may be used in the case where a secure communication channel is needed but the one or more trigger events were not satisfied or a SA Query failure message was returned. If one of these exceptions occur and the packet does not match an existing SA, as determined in decision block 412, the SA is negotiated in block 416 by sending a SA Negotiation Request to the key management daemon or exchange. If the SA negotiation was successful (a negotiated SA pair is received from the key management daemon or exchange), as determined in decision block 418, the resulting SA is stored in the SAD in block 420 and the packet is sent to the destination via the secure communication channel in block 414. If, however, the SA negotiation failed (a negotiation failure message is received from the key management daemon or exchange), as determined in decision block 418, a failure notification is sent to the responsible application in block 422 and the packet will likely be lost.

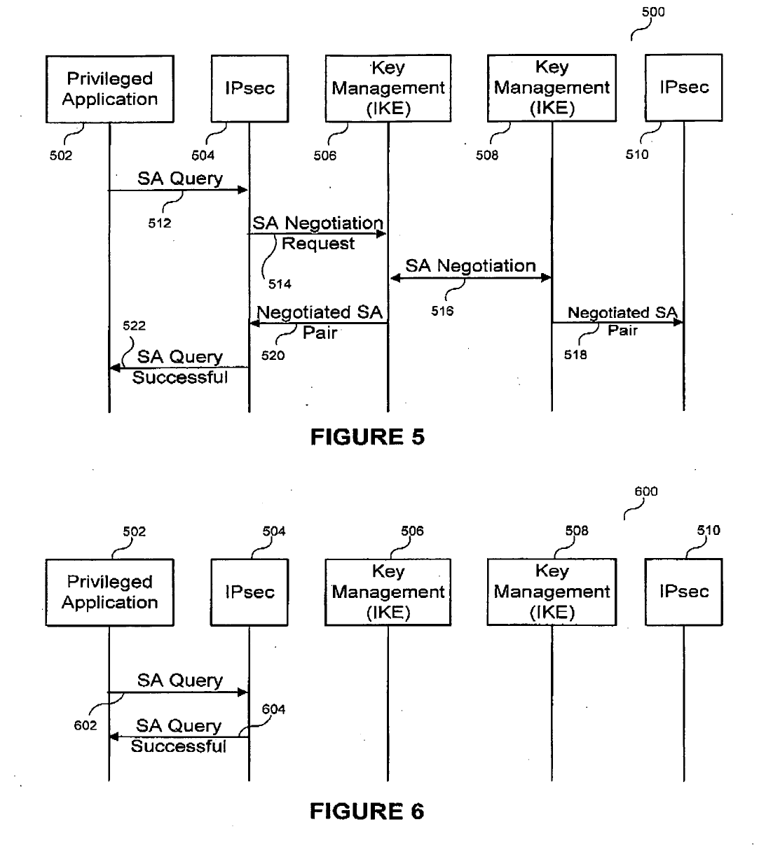

Now referring to FIG. 5, a signaling diagram 500 for a SA Query resulting in a successful SA negotiation in accordance with one embodiment of the present invention is shown. The privileged application 502 sends a SA Query 512 to IPsec 504. IPsec 504 sends a SA Negotiation Request 514 to the Key Management Exchange (“IKE”) 506. IKE 506 then negotiates the SA (SA Negotiation 516) with the peer IKE 508. If the negotiation is successful, the peer IKE 508 sends the Negotiated SA Pair 518 to the peer IPsec 510 and IKE 506 sends the Negotiated SA Pair 520 to IPsec 504, which in turns send a SA Query Successful message 522 to the privileged application 502.

Referring now to FIG. 6, a signaling diagram 600 for a SA Query when a matching SA exists in accordance with one embodiment of the present invention is shown. The privileged application 502 sends a SA Query 602 to IPsec 504. IPsec 504 determines that a SA matches the SA Query 602 and returns a SA Query Successful message 604 to the privileged application 502. This indicates that a secure communication channel already exists.

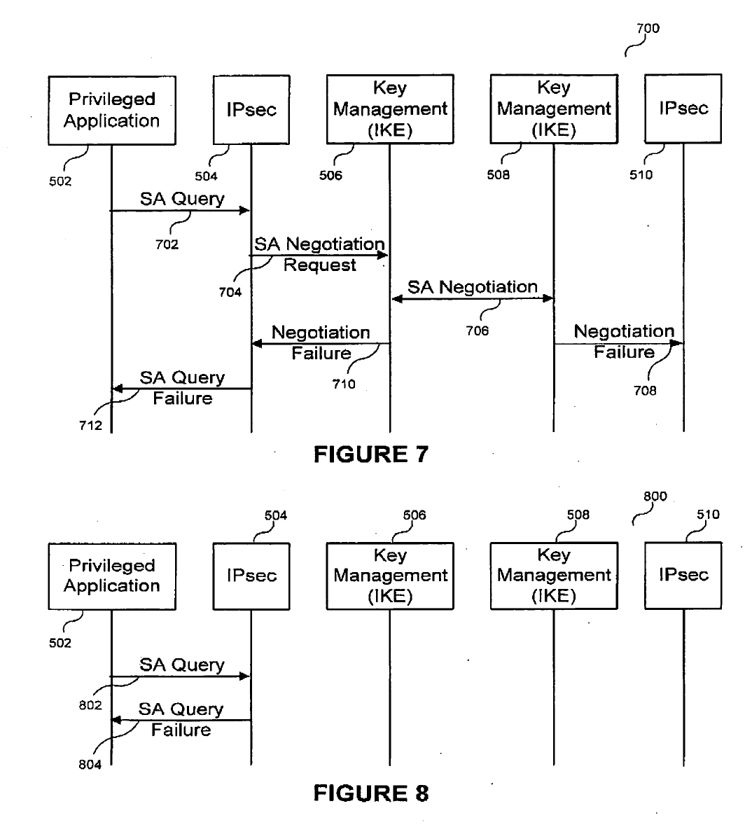

Now referring to FIG. 7, a signaling diagram 700 for a SA Query resulting in a failed SA negotiation in accordance with one embodiment of the present invention is shown. The privileged application 502 sends a SA Query 702 to IPsec 504. IPsec 504 sends a SA Negotiation Request 704 to IKE 506. IKE 506 then negotiates the SA (SA Negotiation 706) with the peer IKE 508. If the negotiation fails, the peer IKE 508 sends the Negotiated Failure message 708 to the peer IPsec 510 and IKE 506 sends the Negotiated Failure message 710 to IPsec 504, which in turns sends a SA Query Failure message 712 to the privileged application 502.

Referring now to FIG. 8, a signaling diagram 800 for a SA Query when no matching SP exists in accordance with one embodiment of the present invention is shown. The privileged application 502 sends a SA Query 802 to IPsec 504. IPsec 504 determines that the SA Query 802 does not match a SP and returns a SA Query Failure message 804 to the privileged application 502.

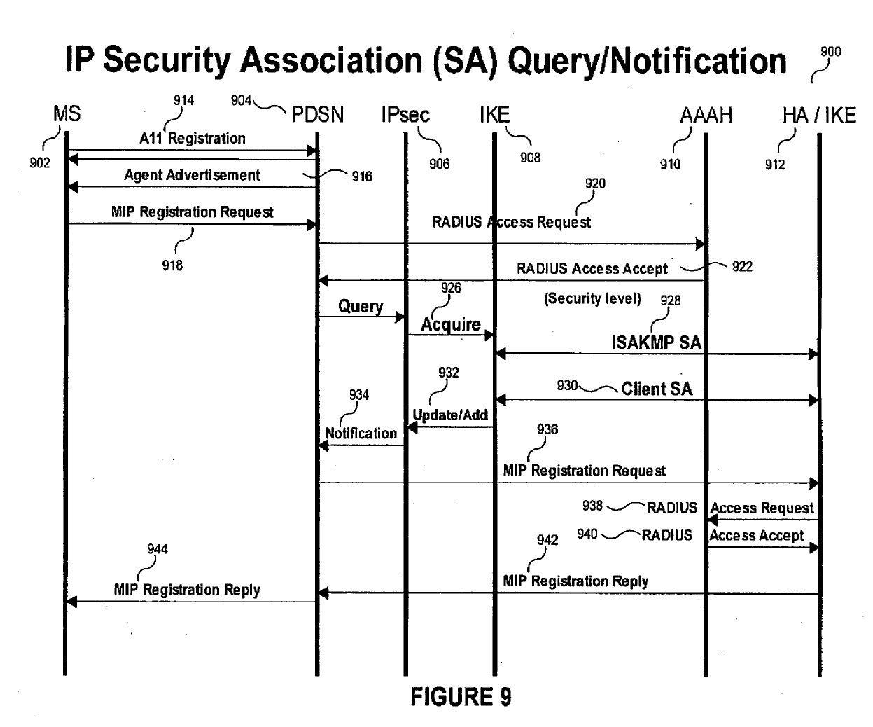

An example of the present invention will now be described in reference to a CDMA system (FIGS. 9-13). This implementation of the invention is not restricted to a specific radio access technology. In principle the invention could also be used in an embodiment in which a client attaches an IP network via a fixed dial-in connection. The present invention affects the interface between the IP/IPsec layer and an application program. The present invention can be implemented as a proprietary system or as a modification of the standard describing the interface between the IP/IPsec layer and an application.

Now referring to FIG. 9, a signaling diagram 900 for a Packet Data Serving Node (“PDSN”) 904 in accordance with another embodiment of the present invention is shown. Mobile Station (“MS”) 902 registration acts as trigger for possible IPsec connection setup. There might be a need for securing the traffic of the MS 902 between PDSN 904 and the Home Agent (“HA”) 912. This need is specified in the MS profile as a security level (1-4), which PDSN 904 obtains for the MS 902 using the Authentication, Authorization and Accounting (“AAAH”) server 910. The PDSN 904 then uses a SA Query to establish IPsec connections between PDSN 904 and HA 912 according to the security level.

More specifically, MS 902 establishes a PPP connection with the PDSN 904 using All Registration 914. PDSN 904 sends Mobile IP (“MIP”) Agent Advertisement 916 back to MS 902 via the PPP link. MS 902 then sends a MIP Registration Request 918 to PDSN 904, which sends a Remote Authentication Dial In User Service (“RADIUS”) Access Request 920 to AAAH 910. AAAH 910 returns a RADIUS Access Accept (including security level) 922 to PDSN 904. PDSN 904 sends a SA Query 924 to IPsec 906, which sends a Negotiation Request (Acquire 926) to IKE 908. IKE 908 negotiates the SA with the peer IKE at HA 912 via Internet Security Association and Key Management Protocol (“ISAKMP”) SA 928 and Client SA 930. IKE 908 sends the SA to IPsec 932 via Update/Add message 932. IPsec 932 then sends a SA Query successful message (Notification 934) to PDSN 904. PDSN 904 then sends MIP Registration Request 936 to HA 912, which sends RADIUS Access Request 938 to AAAH 910. AAAH 910 sends RADIUS Access Accept 940 to HA 912. HA 912 sends MIP Registration Reply 942 to PDSN 904, which sends MIP Registration Reply 944 to MS 902.

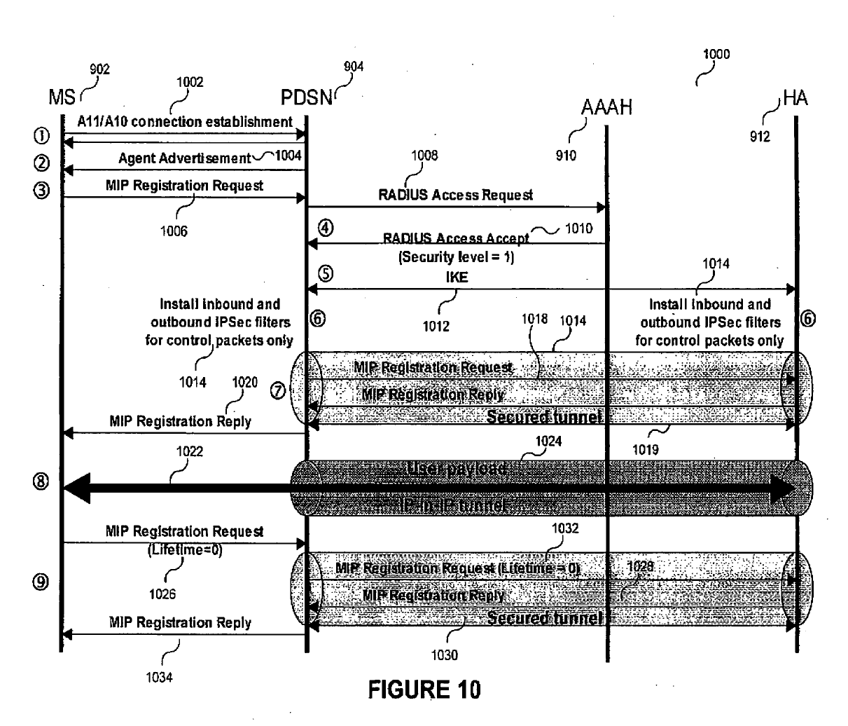

Referring now FIG. 10, a signaling diagram 1000 for a PDSN 904 providing security level one (control only) in accordance with another embodiment of the present invention is shown. MS 902 establishes a PPP connection with the PDSN 904 via A11/A10 connection establishment 1002. PDSN 904 sends MIP Agent Advertisement 1004 back to MS 902 via the PPP link. MS 902 then sends a MIP Registration Request 1006 to PDSN 904. The PDSN 904 authenticates the MS 902 using Password Authentication Protocol (“PAP”) or Challenge Authentication Protocol (“CHAP”) (RADIUS Access Request 1008) with the home AAAH 910, and obtains the security level (=1) (RADIUS Access Accept 1010) and optionally the HA 912 IP address. If there is no security association already established with the HA 912, IKE 1012 is used to establish the security policies and associations (PDSN uses SA Query to start IKE 1012). In this case, the IKE process 1012 installs inbound and outbound IPsec filters for control packets only 1014 at PDSN 904 and HA 912. This creates the secured tunnels 1019 and 1032. The PDSN 904 forwards the MIP Registration Request 1016 to the HA 912 and the HA 912 returns the MIP Registration Reply 1018 in the secured tunnel 1019. The PDSN 904 relays the MIP Registration Reply 1020 to the MS 902. The MS 902 sends data 1022 through the IP-in-IP tunnel 1024 between the PDSN 904 and HA 912. After the data transfer is complete, the MS 902 sends a MIP Registration Request 1026 with lifetime=0 to de-register from the HA 912. The PDSN 904 forwards the MIP Registration Request 1028 to the HA 912 and the HA 912 returns the MIP Registration Reply 1030 in the secured tunnel 1032. The PDSN 904 relays the MIP Registration Reply 1034 to the MS 902.

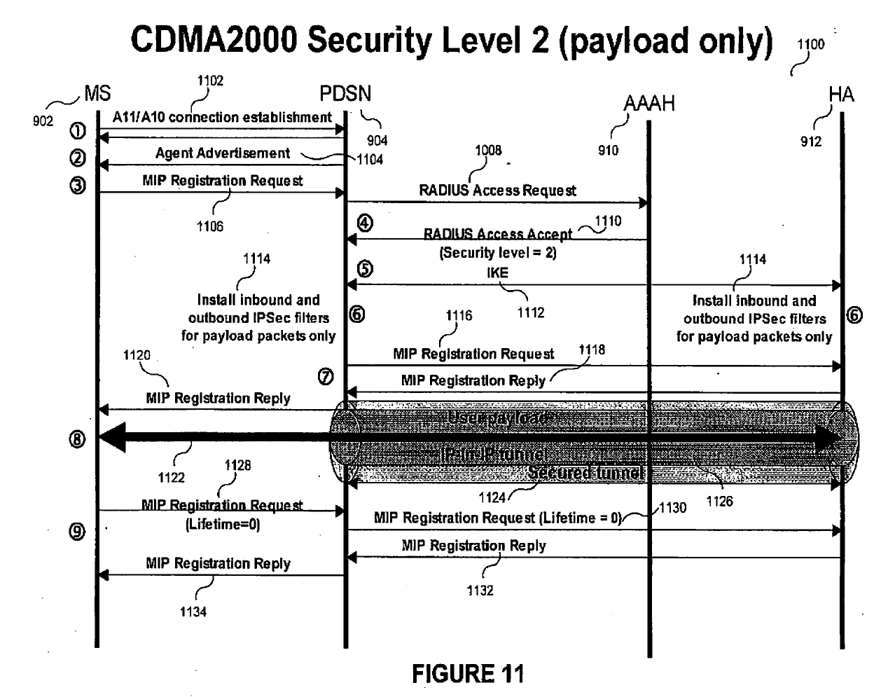

Now referring to FIG. 11, a signaling diagram 1100 for a PDSN 904 providing security level two (payload only) in accordance with another embodiment of the present invention is shown. MS 902 establishes a PPP connection with the PDSN 904 via A11/A10 connection establishment 1102. PDSN 904 sends MIP Agent Advertisement 1104 back to MS 902 via the PPP link. MS 902 then sends a MIP Registration Request 1106 to PDSN 904. The PDSN 904 authenticates the MS 902 using PAP or CHAP (RADIUS Access Request 1108) with the home AAAH 910, and obtains the security level (=2) (RADIUS Access Accept 1110) and optionally the HA 912 IP address. If there is no security association already established with the HA 912, IKE 1112 is used to establish the security policies and associations (PDSN uses SA Query to start IKE 1112). In this case, the IKE process 1112 installs inbound and outbound IPsec filters for payload packets only 1114 at PDSN 904 and HA 912. This creates the secured tunnel 1124. The PDSN 904 forwards the MIP Registration Request 1116 to the HA 912 and the HA 912 returns the MIP Registration Reply 1118. The PDSN 904 relays the MIP Registration Reply 1120 to the MS 902. The MS 902 sends data 1122 through the IP-in-IP tunnel 1026 in secured tunnel 1124 between the PDSN 904 and HA 912. After the data transfer is complete, the MS 902 sends a MIP Registration Request 1128 with lifetime=0 to de-register from the HA 912. The PDSN 904 forwards the MIP Registration Request 1130 to the HA 912 and the HA 912 returns the MIP Registration Reply 1032. The PDSN 904 relays the MIP Registration Reply 1034 to the MS 902.

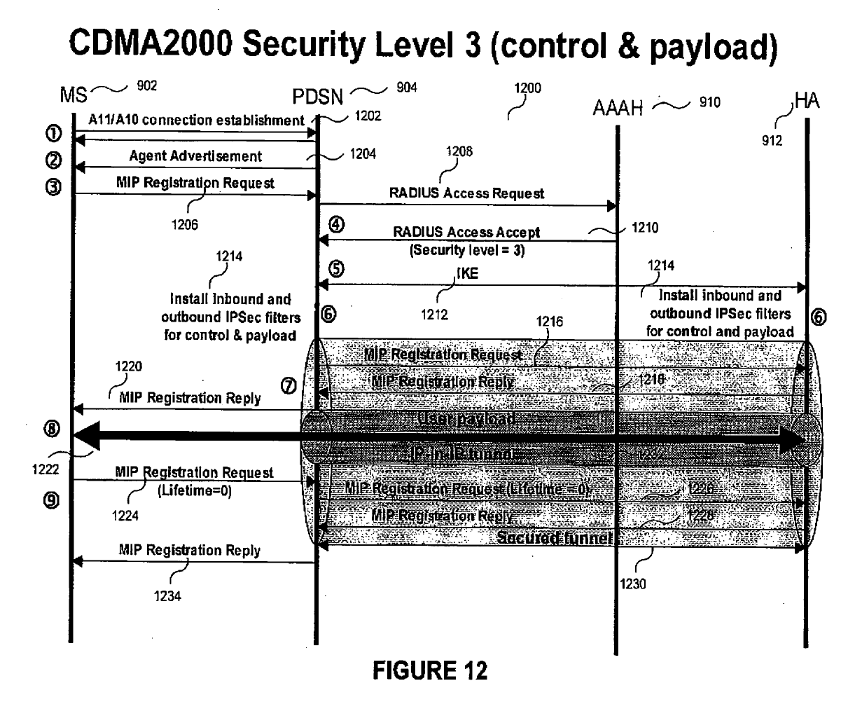

Referring now to FIG. 12, a signaling diagram 1200 for a PDSN 904 providing security level three (control and payload) in accordance with another embodiment of the present invention is shown. MS 902 establishes a PPP connection with the PDSN 904 via A11/A10 connection establishment 1202. PDSN 904 sends MIP Agent Advertisement 1204 back to MS 902 via the PPP link. MS 902 then sends a MIP Registration Request 1206 to PDSN 904. The PDSN 904 authenticates the MS 902 using PAP or CHAP (RADIUS Access Request 1208) with the home AAAH 910, and obtains the security level (=3) (RADIUS Access Accept 1210) and optionally the HA 912 IP address. If there is no security association already established with the HA 912, IKE 1212 is used to establish the security policies and associations (PDSN uses SA Query to start IKE 1212). In this case, the IKE process 1212 installs inbound and outbound IPsec filters for both control and payload packets 1214 at PDSN 904 and HA 912. This creates the secured tunnel 1230. The PDSN 904 forwards the MIP Registration Request 1216 to the HA 912 and the HA 912 returns the MIP Registration Reply 1218 in the secured tunnel 1230. The PDSN 904 relays the MIP Registration Reply 1220 to the MS 902. The MS 902 sends data 1222 through the IP-in-IP tunnel 1232 in secured tunnel 1130 between the PDSN 904 and HA 912. After the data transfer is complete, the MS 902 sends a MIP Registration Request 1224 with lifetime=0 to de-register from the HA 912. The PDSN 904 forwards the MIP Registration Request 1226 to the HA 912 and the HA 912 returns the MIP Registration Reply 1228 in secured tunnel 1230. The PDSN 904 relays the MIP Registration Reply 1234 to the MS 902.

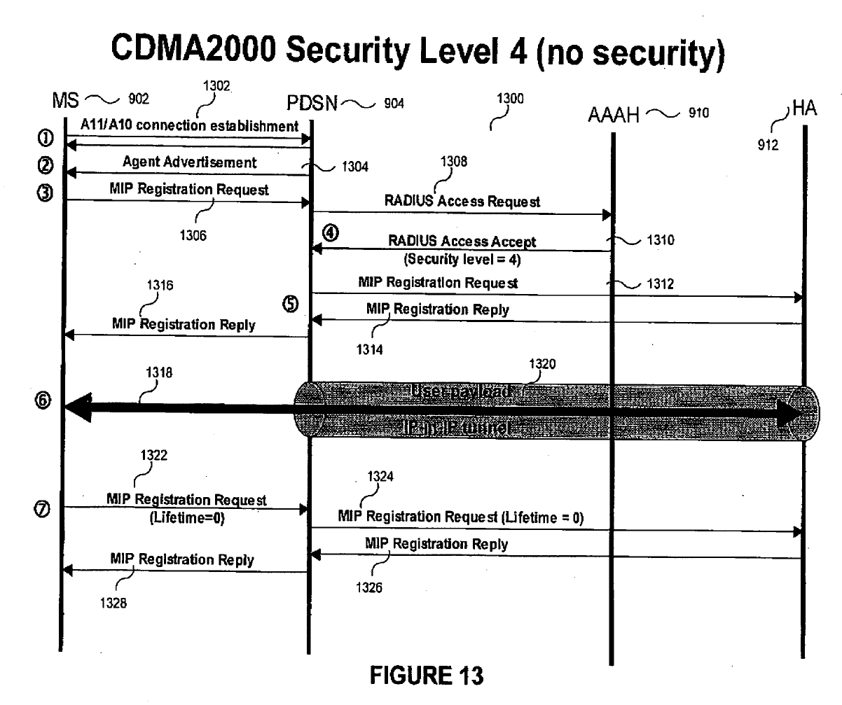

Now referring to FIG. 13, a signaling diagram 1300 for a PDSN 904 providing security level four (no security) in accordance with another embodiment of the present invention is shown. MS 902 establishes a PPP connection with the PDSN 904 via A11/A10 connection establishment 1302. PDSN 904 sends MIP Agent Advertisement 1304 back to MS 902 via the PPP link. MS 902 then sends a MIP Registration Request 1306 to PDSN 904. The PDSN 904 authenticates the MS 902 using PAP or CHAP (RADIUS Access Request 1308) with the home AAAH 910, and obtains the security level (=4) (RADIUS Access Accept 1310) and optionally the HA 912 IP address. The PDSN 904 forwards the MIP Registration Request 1312 to the HA 912 and the HA 912 returns the MIP Registration Reply 1314. The PDSN 904 relays the MIP Registration Reply 1316 to the MS 902. The MS 902 sends data 1318 through the IP-in-IP tunnel 1320 between the PDSN 904 and HA 912. After the data transfer is complete, the MS 902 sends a MIP Registration Request 1322 with lifetime=0 to de-register from the HA 912. The PDSN 904 forwards the MIP Registration Request 1324 to the HA 912 and the HA 912 returns the MIP Registration Reply 1326. The PDSN 904 relays the MIP Registration Reply 1328 to the MS 902.

Although preferred embodiments of the present invention have been described in detail, it will be understood by those skilled in the art that various modifications can be made therein without departing from the spirit and scope of the invention as set forth in the appended claims.

1. A method for pre-establishing a secure communication channel comprising the steps of:
detecting one or more trigger events;
determining whether the secure communication channel will be needed in the future; and
establishing the secure communication channel before the secure communication channel is needed.

2. The method as recited in claim 1, wherein the one or more trigger events include a registration request, an attachment of a client or an expected attachment of a client.

3. The method as recited in claim 1, wherein the step of determining whether the secure communication channel will be needed in the future is based on a user profile or historical data.

4. The method as recited in claim 1, wherein the secure communication channel is needed whenever a control packet or payload packet is received that relates to the one or more trigger events and matches one or more security policies.

5. The method as recited in claim 1, further comprising the step of storing an indication that the secure communication channel has been established.

6. The method as recited in claim 1, further comprising the steps of:
receiving a control or payload packet;
determining whether the received packet is associated with the pre-established secure communication channel; and
sending the received packet using the pre-established secure communication channel whenever the received packet is associated with the pre-established secure communication channel.

7. The method as recited in claim 1, wherein the step of establishing the secure communication channel comprises the steps of:
sending a security association query (“SA Query”) to a packet security protocol instance, the SA Query comprising a message indicating that a security association is needed;
receiving a SA Query successful message from the packet security protocol instance whenever the secure communication channel has been established; and
receiving a SA Query failure message from the packet security protocol instance whenever the secure communication channel has not been set up.

8. The method as recited in claim 7, wherein the packet security protocol instance is an IPsec protocol instance.

9. The method as recited in claim 7, wherein the SA Query includes a set of packet selectors comprising:
a source address;
a destination address;
a protocol;
a source port; and
a destination port.

10. The method as recited in claim 7, wherein the secure communication channel is for control packets only, payload packets only, or both control and payload packets.

11. A method for pre-establishing a secure communication channel comprising the steps of:
receiving a security association query (“SA Query”) from a privileged application, the SA Query comprising a message indicating that a security association is needed;
determining whether the SA Query matches one or more security policies;
determining whether the SA Query matches a security association whenever the SA Query matches the one or more security policies;
sending a SA Negotiation Request to a key management exchange whenever the SA Query does not match the security association;
sending a SA Query successful message to the privileged application indicating that the secure communication channel has been pre-established whenever the SA Query matches the security association or a negotiated SA pair is received from the key management exchange; and
sending a SA Query failure message to the privileged application whenever the SA Query does not match the one or more security policies or a negotiation failure message is received from the key management exchange.

12. The method as recited in claim 11, wherein the privileged application is a management application.

13. The method as recited in claim 11, wherein the privileged application is a packet data serving node (“PDSN”).

14. The method as recited in claim 11, wherein the security policies are stored in security policies database (“SPD”).

15. The method as recited in claim 11, wherein the security associations are stored in a security association database (“SAD”).

16. The method as recited in claim 11, wherein the key management exchange is an Internet key exchange (“IKE”).

17. A computer program embodied on a computer readable medium for pre-establishing a secure communication channel comprising:
a code segment for detecting one or more trigger events;
a code segment for determining whether the secure communication channel will be needed in the future; and
a code segment for establishing the secure communication channel before the secure communication channel is needed.

18. The computer program as recited in claim 17, wherein the one or more trigger events include a registration request, an attachment of a client or an expected attachment of a client.

19. The computer program as recited in claim 17, wherein the code segment for determining whether the secure communication channel will be needed in the future is based on a user profile or historical data.

20. The computer program as recited in claim 17, wherein the secure communication channel is needed whenever a control packet or payload packet is received that relates to the one or more trigger events and matches one or more security policies.

21. The computer program as recited in claim 17, further comprising a code segment for storing an indication that the secure communication channel has been established.

22. The computer program as recited in claim 17, further comprising:
a code segment for receiving a control or payload packet;
a code segment for determining whether the received packet is associated with the pre-established secure communication channel; and
a code segment for sending the received packet using the pre-established secure communication channel whenever the received packet is associated with the pre-established secure communication channel.

23. The computer program as recited in claim 17, wherein the code segment for establishing the secure communication channel comprises:
a code segment for sending a security association query (“SA Query”) to a packet security protocol instance, the SA Query comprising a message indicating that a security association is needed;
a code segment for receiving a SA Query successful message from the packet security protocol instance whenever the secure communication channel has been established; and
a code segment for receiving a SA Query failure message from the packet security protocol instance whenever the secure communication channel has not been set up.

24. The computer program as recited in claim 23, wherein the packet security protocol instance is an IPsec protocol instance.

25. The computer program as recited in claim 23, wherein the SA Query includes a set of packet selectors comprising:
a source address;
a destination address;
a protocol;
a source port; and
a destination port.

26. The computer program as recited in claim 23, wherein the secure communication channel is for control packets only, payload packets only, or both control and payload packets.

27. A computer program embodied on a computer readable medium for pre-establishing a secure communication channel comprising:
a code segment for receiving a security association query (“SA Query”) from a privileged application, the SA Query comprising a message indicating that a security association is needed;
a code segment for determining whether the SA Query matches one or more security policies;
a code segment for determining whether the SA Query matches a security association whenever the SA Query matches the one or more security policies;
a code segment for sending a SA Negotiation Request to a key management exchange whenever the SA Query matches the security association;
a code segment for sending a SA Query successful message to the privileged application indicating that the secure communication channel has been pre-established whenever the SA Query matches the security association or a negotiated SA pair is received from the key management exchange; and
a code segment for sending a SA Query failure message to the privileged application whenever the SA Query does not match the one or more security policies or a negotiation failure message is received from the key management exchange.

28. The computer program as recited in claim 27, wherein the privileged application is a management application.

29. The computer program as recited in claim 27, wherein the privileged application is a packet data serving node (“PDSN”).

30. The computer program as recited in claim 27, wherein the security policies are stored in security policies database (“SPD”).

31. The computer program as recited in claim 27, wherein the security associations are stored in a security association database (“SAD”).

32. The computer program as recited in claim 27, wherein the key management exchange is an Internet key exchange (“IKE”).

33. An apparatus comprising:
a packet processor;
a packet security protocol instance operating within the packet processor; and
a privileged application operating within the packet processor that detects one or more trigger events, determines whether a secure communication channel will be needed in the future and sends a message to the packet security protocol instance to establish the secure communication channel before the secure communication channel is needed.

34. The apparatus as recited in claim 33, wherein the one or more trigger events include a registration request, an attachment of a client or an expected attachment of a client.

35. The apparatus as recited in claim 33, wherein the privileged application determines whether the secure communication channel will be needed in the future based on a user profile or historical data.

36. The apparatus as recited in claim 33, wherein the secure communication channel is needed whenever a control packet or payload packet is received that relates to the one or more trigger events and matches one or more security policies.

37. The apparatus as recited in claim 33, wherein the privileged application stores an indication that the secure communication channel has been established.

38. The apparatus as recited in claim 33, wherein the privileged application receives a control or payload packet, determines whether the received packet is associated with the pre-established secure communication channel, and sends the received packet using the pre-established secure communication channel whenever the received packet is associated with the pre-established secure communication channel.

39. The apparatus as recited in claim 33, wherein the privileged application establishes the secure communication channel by sending a security association query (“SA Query”) to the packet security protocol instance, the SA Query comprising a message indicating that a security association is needed.

40. The apparatus as recited in claim 33, wherein the packet security protocol instance is an IPsec protocol instance.

41. The apparatus as recited in claim 33, wherein the secure communication channel is for control packets only, payload packets only, or both control and payload packets.

42. The apparatus as recited in claim 33, further comprising:
a security policies database communicably coupled to the packet security protocol;
a security association database communicably coupled to the packet security protocol;
a key management daemon communicably coupled to the packet security protocol;
the packet security protocol receiving a security association query (“SA Query”) from the privileged application, the SA Query comprising a message indicating that a security association is needed, determining whether the SA Query matches one or more security policies stored in the securities policies database, determining whether the SA Query matches a security association stored in the security association database whenever the SA Query matches the one or more security policies, sending a SA Negotiation Request to the key management daemon whenever the SA Query matches the security association, sending a SA Query successful message to the privileged application indicating that the secure communication channel has been pre-established whenever the SA Query matches the security association or a negotiated SA pair is received from the key management exchange, and sending a SA Query failure message to the privileged application whenever the SA Query does not match the one or more security policies or a negotiation failure message is received from the key management exchange.

43. The apparatus as recited in claim 42, wherein the privileged application is a management application.

44. The apparatus as recited in claim 42, wherein the privileged application is a packet data serving node (“PDSN”).

45. The apparatus as recited in claim 42, wherein the key management exchange is an Internet key exchange (“IKE”).

46. The apparatus as recited in claim 42, wherein the apparatus is a gateway, router, firewall, server, communications node or switch.

47. A system comprising:
a first network;
a second network; and
a packet communications device communicably coupled to the first network and the second network, the packet communications device comprising a packet processor, a packet security protocol instance operating within the packet processor, and a privileged application operating within the packet processor that detects one or more trigger events, determines whether a secure communication channel will be needed in the future and sends a message to the packet security protocol instance to establish the secure communication channel before the secure communication channel is needed.

48. The system as recited in claim 47, wherein the first network is the Internet and further comprising one or more computers or IP phones communicably coupled to the Internet.

49. The system as recited in claim 47, wherein the second network is a local area network and further comprising one or more computers or personal data assistants communicably coupled to the local area network.

50. The system as recited in claim 47, wherein the second network is an access network and further comprising one or more mobile stations communicably coupled to the access network.
